(19) United States
(12) Patent Application Publication
(10) Pub. No.: US 2018/0239406 A1
(43) Pub. Date: Aug. 23, 2018

(54) SMART POWER SUPPLY MANAGEMENT FOR HIGH STANDBY POWER SYSTEM BACKGROUND

(71) Applicant: QUANTA COMPUTER INC., Taoyuan City (TW)

(72) Inventors: Jen-Hsuen HUANG, Taoyuan City (TW); Fa-Da LIN, Taoyuan City (TW); Yi-Ping LIN, Taoyuan City (TW)

(21) Appl. No.: 15/440,789

(22) Filed: Feb. 23, 2017

(51) Int. Cl. G06F 1/26

(52) U.S. Cl. CPC G06F 1/263

(57) ABSTRACT

A control circuit for managing a power supply unit (PSU) of a system board, routes a standby power port of the system board to a standby power port of the PSU. The control circuit monitors at least one electrical parameter for the standby power port of the system board by using a sensor, and determines that the at least one electrical parameter meets a criteria. The control circuit transmits an enable signal configured for enabling a main power port of the PSU coupled a the main power port of the system board and rerouting the standby power port of the system board to the main power port of the PSU, in response to determining that the at least one electrical parameter meets the criteria.

### BACKGROUND

### Field

This application relates to computer systems, and more particularly to a system and method for managing a power supply.

### Background

Server systems include one or more power supply units (PSUs) to supply the server systems with direct current (DC) power. A PSU may be configured to convert power in one form to another form, such as converting alternating current (“AC”) power to direct current (“DC”) power.

PSUs can also provide auxiliary and standby power to background systems and sub-systems within an electronic device. For example, even when an electronic device is not fully operational, in standby mode (indicating a mode for maintaining a ready state before the electronic product is normally operated), sleep mode, or is turned off, power may still be needed to power system clocks, system controllers, system monitors and the like. Conventional PSUs typically include several stages of power conversion in order to provide main power as well as standby power.

### SUMMARY

The following presents a simplified summary of one or more embodiments in order to provide a basic understanding of present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In accordance with one or more aspects of the examples described herein, systems and methods are provided for managing a power supply.

In an aspect, a control circuit for managing a power supply unit (PSU) of a system board, routes a standby power port of the system board to a standby power port of the PSU. The control circuit monitors at least one electrical parameter for the standby power port of the system board using a sensor, and determines that the at least one electrical parameter meets a criteria. The control circuit transmits an enable signal configured for enabling a main power port of the PSU coupled a the main power port of the system board and rerouting the standby power port of the system board to the main power port of the PSU, in response to determining that the at least one electrical parameter meets the criteria.

In an aspect, the control circuit further determines that the at least one electrical parameter no longer meets the criteria and transmits a disable signal configured for disabling a main power port of the PSU coupled to the main power port of the system board and rerouting the standby power port of the system board to the standby power port of the PSU, in response to determining that the at least one electrical parameter no longer meets the criteria.

In an aspect, a control circuit for managing a power supply unit (PSU) associated with a system board includes a switching circuit, a sensor, and a logic circuit. The switching circuit selectively couples a standby power port of the system board to one of a standby power port of the PSU or a main power port of the PSU. The sensor for generates current signals corresponding to a current flowing into the standby power port of the system board. The logic circuit is configured to determine, based on the current signals, that at least one electrical parameter for the standby power port of the system board meets a criteria, and generate an enable signal configured for enabling a main power port of the PSU coupled to the main power port of the system board and causing the switching circuit to route a standby power port of the system board to a main power port of the PSU, in response to determining that the at least one electrical parameter meets the criteria.

### BRIEF DESCRIPTION OF THE DRAWINGS

These and other sample aspects of the present technology will be described in the detailed description and the appended claims that follow, and in the accompanying drawings, wherein:

FIG. 1 illustrates a block diagram of a system for managing a power supply in the prior art;

FIG. 2 illustrates a block diagram of an example system for managing a power supply, according to certain aspects of the subject technology;

FIG. 3 illustrates an example methodology for managing a power supply of a system board by a control circuit.

FIG. 4 illustrates an example methodology for managing a power supply of a system board by a control circuit; and

FIG. 5 illustrates a block diagram of an example computer system.

### DETAILED DESCRIPTION

The subject disclosure provides techniques for managing network configurations in a server system, in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

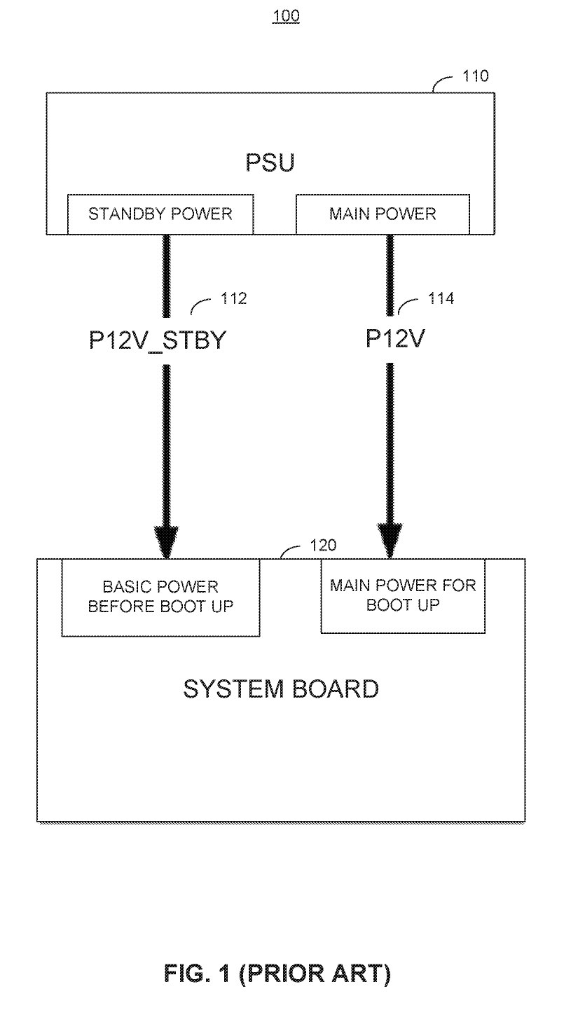

FIG. 1 illustrates a block diagram of a system 100 for managing a power supply 110 in the prior art. The system 100 includes the PSU 110 to supply a system board 120 with direct current (DC) power. The PSU 110 may be configured to convert power in one form to another form, such as converting alternating current (“AC”) power to DC power.

In addition to main power 114, the PSU 100 also provides standby/auxiliary power 112 to background systems and sub-systems 112 within the system board 120. For example, even when the system board 120 is not fully operational, in standby mode (indicating a mode for maintaining a ready state before the electronic product is normally operated), sleep mode, or is turned off, power may still be needed to power system clocks, system controllers, system monitors and the like.

The PSU includes several stages of power conversion in order to provide main power 114 as well as the standby power 112. The PSU 110 can include a separate independent auxiliary converter in order to provide the standby power 112, in addition to a main converter for providing a main power 114. The PSU supplies the main power 114 to system board 120 through a main converter during an operation of system board 120, and supplies the standby power 112 to the system board 120 through the auxiliary converter during a standby mode.

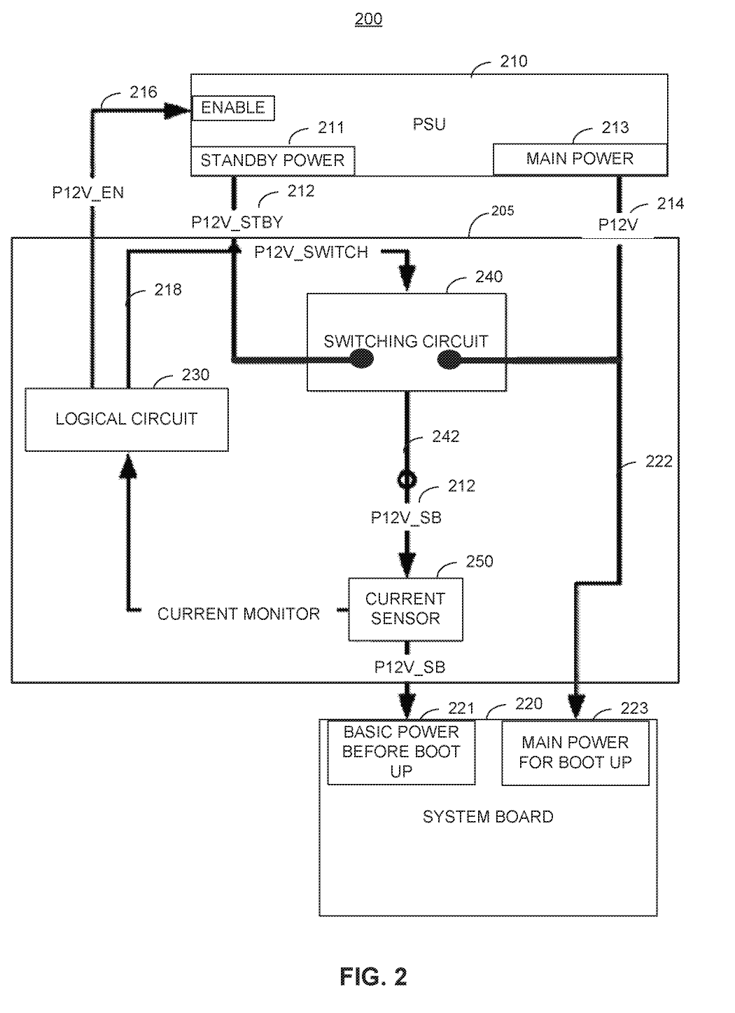

FIG. 2 illustrates a block diagram of an example system 200 for managing a power supply 210, according to certain aspects of the subject technology. The system 200 includes the PSU 210 to supply a system board 220 with direct current (DC) power. A control circuit 205 manages the PSU 210.

The PSU 210 may be configured to convert power in one form to another form, such as converting alternating current (“AC”) power to DC power. The regulation of PSUs 210 can include incorporating circuitry to tightly control the output voltage and/or current of the PSU 210 to a specific value. The specific value is typically closely maintained despite variations in the load presented to the PSU's output.

In the system 200, the PSU 210 typically converts an AC voltage input into several low-voltage DC power outputs for transmission to various system components. AC to DC conversion is typically performed in stages such as a rectification stage, a pre-regulation stage, a regulator/chopper stage, etc.

In addition to main power 214, the PSU 210 also provides standby/auxiliary power 212 to background systems and sub-systems within the system 200, such as for when the system 200 is in standby mode or powered off (indicating main power of the system 200 is powered off). For example, even when the system board 220 is not fully operational, in standby mode (indicating a mode for maintaining a ready state before the electronic product is normally operated), sleep mode, or is powered off, power may still be needed to power system clocks, system controllers, system monitors and the like.

The PSU 210 can include several stages of power conversion in order to provide main power 214 as well as the standby power 212. The PSU 210 can include a separate independent auxiliary converter in order to provide the standby power 212, in addition to a main converter for providing a main power 214. The PSU 210 supplies the main power 214 to a main power port 223 of the system board 220 during while the system 200 is powered on. The PSU 210 supplies the standby power 212 to the system board 220 to the standby power port 221 of the system board 220 while the system 200 is powered off or in standby mode.

The control circuit 205 determines if and when to enable the main power 214 of the PSU 210. The control circuit 205 routes either a standby power port 211 or a main power port 213 of the PSU 210 to a standby power port 221 of the system board 220.

The control circuit 205 allows enabling of the main power 214 of the PSU 210 even when the system 200 is not powered on, such as in cases when a large number of low-power circuits are present in the system 200 that still draw power when the system 200 is powered off or in standby mode. The control circuit 205 shown includes a switching circuit 240, a logical circuit 230, and a sensor 250. It is noted that the control circuit 205 can include different components than what is shown to perform functionalities of the control circuit 205. When the system 200 is powered off or in a standby mode, the PSU 210 initially only provides standby power 212 to the system board 220. Initially, the logic circuit 205 may control the PSU 210 to have the main power 214 disabled.

The sensor 250 monitors at least one electrical parameter for the standby power port of the system board 220. For example, the electrical parameter can include a current level, voltage level, and/or a power level that is consumed by the system board. In some implementations, the electrical parameter includes an average current, voltage, or power consumption over a period of time. In some implementations, the sensor 250 is a power sensor that monitors a power level of the standby power 212. In some implementations, the sensor 250 is a current sensor that measures a current level of the standby power 212. The sensor 250 outputs the at least one electrical parameter to the logic circuit 230.

The logic circuit 230 determines whether the at least one electrical parameter from the sensor 250 meets a criteria. In some implementations, the criteria are met if the power level of consumed by the system board 220 meets or exceeds a threshold power value. In some implementations, the criteria is met if the current level of consumed by the system board 220 meets or exceeds a threshold current value. In some implementations, the criteria are met if the power/current level consumed by the system board 220 is above the threshold power/current level for a specified period of time.

In some implementations, the threshold power/current level is set to a level at or slightly below an amount of power/current that the standby power 212 of the PSU 210 can provide. In some implementations, the threshold power/current level is set by an administrator, before or during installation of the system 200. In some other implementations, the threshold power/current level is automatically determined by a processing circuit (not shown), of the control circuit 205, a baseboard management controller (BMC), or processor of the system 200.

In some implementations, when the at least one electrical parameter from the sensor 250 meets a criteria, the logic circuit 230 sends an enablement signal 216 to the PSU 210 to command the PSU 210 to enable the main power 214. In some implementations, the logic circuit 230 sends a switch signal 218 to the switching circuit 240 to switch the system board 220 to receive power from the main power 214 instead of (or in addition to, in some implementations) the standby power 212 at the standby power port 221 of the system board 220.

When the system 200 is not powered on, the switching circuit 240 initially directs standby power 212 from the PSU 210 through a standby power line 242. If the at least one electrical parameter meets a criteria, the switching circuit 240, in response to receiving the switching signal 218 from logic circuit 230, routes the main power 214 through the standby power line 242. When the system 200 is powered on, the system board 220 receives power from the main power 214 through the main power line 222 at the main power port 223 of the system board 220.

If the at least one electrical parameter ceases to meet the criteria, after previously meeting the criteria (e.g., such as when standby power consumption by the system 200 is reduced), the logic circuit 230 stops sending the enablement signal 216 to the PSU 210, which then causes the PSU 210 to disable the main power 214. Additionally, the logic circuit 230 commands the switching circuit 240 using the switch signal 218 to reroute the standby power port 221 of the system board 220 to the standby power port 211 of the PSU 210.

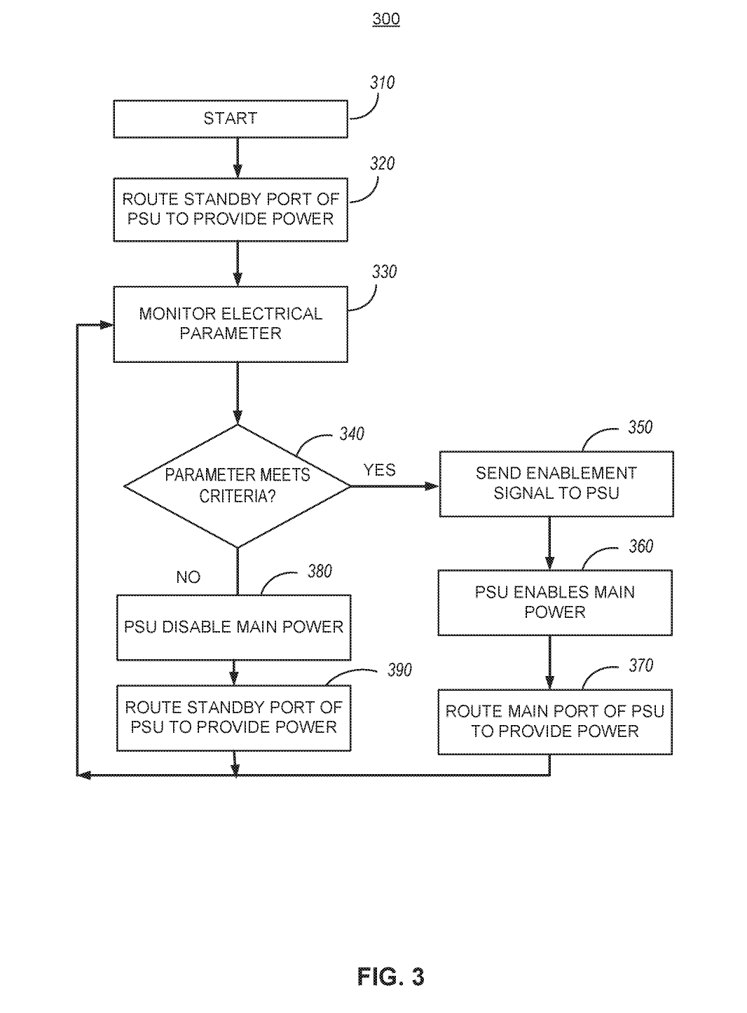

FIG. 3 illustrates a flow chart 300 of an exemplary method for managing a power supply. The method starts at step 310. At step 320, a control circuit routes standby power from a standby port of a PSU to a system board.

At step 330, a sensor monitors at least one electrical parameter for the standby power port. For example, the at least one electrical parameter can include current, power, or voltage. The sensor can be at least one of a current, power, or voltage sensor.

At step 340, a logic circuit determines whether the at least one electrical parameter meets a criteria. For example, as shown in FIG. 2, the logic circuit 230 determines whether the current level read by the current sensor 250 has reached the current threshold.

If the current reaches the current threshold, at step 350, the logic circuit sends an enablement signal to the PSU. For example, as shown in FIG. 2, the logic circuit 230 sends the enablement signal 216 to the PSU 210.

At step 360, the PSU enables main power, in response to receiving the enablement signal from the logic circuit. For example, as shown in FIG. 2, the PSU 210 enables the main power 214 when it receives the enablement signal 216 from the logic circuit 230 at step 370. The method then loops back to step 330.

If the current is under the current threshold, at step 340, the PSU disables (or does not enable) the main power at step 380. Thereafter, at step 390, the control circuit starts or continues to route standby power from a standby port of the PSU to the system board. The method then loops back to step 330.

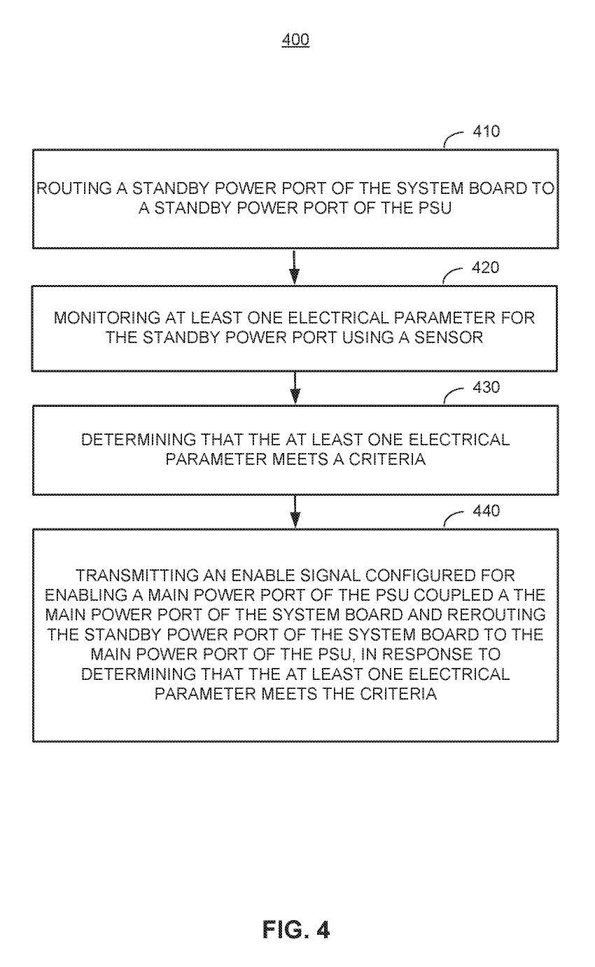

FIG. 4 illustrates an example methodology 400 for managing a PSU of a system board by a control circuit. At step 410, the control circuit routes a standby power port of the system board to a standby power port of the PSU.

At step 420, the control circuit monitors at least one electrical parameter for the standby power port of the system board by using a sensor. In some implementations, the sensor is configured for generating a current signal corresponding to an amount of electrical current flowing into the standby port of the system board. In some implementations, the monitoring comprises calculating the at least one electrical parameter based on the current signal. In some implementations, the at least one electrical parameter comprises at least one of a measure of electrical current or a measure of electrical power.

At step 430, the control circuit determines that the at least one electrical parameter meets a criteria.

At step 440, the control circuit transmits an enable signal configured for enabling a main power port of the PSU coupled the main power port of the system board and rerouting the standby power port of the system board to the main power port of the PSU, in response to determining that the at least one electrical parameter meets the criteria.

In some implementations, the control circuit further determines that the at least one electrical parameter no longer meets the criteria and transmits a disable signal configured for disabling a main power port of the PSU coupled to the main power port of the system board and rerouting the standby power port of the system board to the standby power port of the PSU, in response to determining that the at least one electrical parameter no longer meets the criteria. In some implementations, transmitting the disable signal comprises discontinuing the enable signal.

In some implementations, the standby power port of the system board is selectively coupled to at least one of the main power port of the PSU or the standby power port of the PSU via a switching circuit, and the routing comprises configuring the switching circuit to couple the standby power port of the PSU to the standby power port of the system board, and the re-routing comprises reconfiguring the switch circuit to couple the main power port of the PSU to the standby power port of the system board.

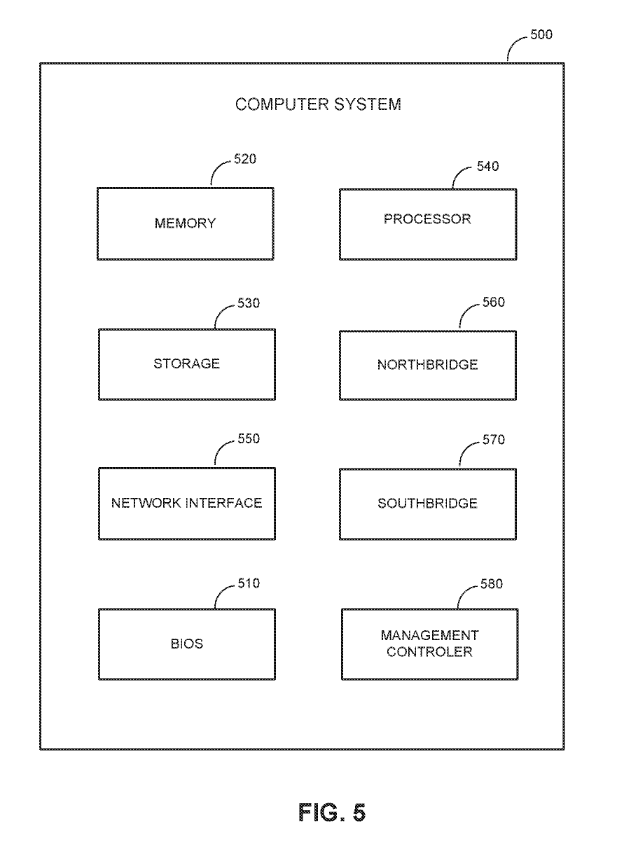

FIG. 5 illustrates a block diagram of an example computer system 500. The computer system 500 can include a processor 540, a network interface 550, a management controller 580, a memory 520, a storage 530, a Basic Input/Output System (BIOS) 510, and a northbridge 560, and a southbridge 570.

The computer system 500 can be, for example, a server (e.g., one of many rack servers in a data center) or a personal computer. The processor (e.g., central processing unit (CPU)) 540 can be a chip on a motherboard that can retrieve and execute programming instructions stored in the memory 520. The processor 540 can be a single CPU with a single processing core, a single CPU with multiple processing cores, or multiple CPUs. One or more buses (not shown) can transmit instructions and application data between various computer components such as the processor 540, memory 520, storage 530, and networking interface 550.

The memory 520 can include any physical device used to temporarily or permanently store data or programs, such as various forms of random-access memory (RAM). The storage 530 can include any physical device for non-volatile data storage such as a HDD or a flash drive. The storage 530 can have a greater capacity than the memory 520 and can be more economical per unit of storage, but can also have slower transfer rates.

The BIOS 510 can include a Basic Input/Output System or its successors or equivalents, such as an Extensible Firmware Interface (EFI) or Unified Extensible Firmware Interface (UEFI). The BIOS 510 can include a BIOS chip located on a motherboard of the computer system 500 storing a BIOS software program. The BIOS 510 can store firmware executed when the computer system is first powered on along with a set of configurations specified for the BIOS 510. The BIOS firmware and BIOS configurations can be stored in a non-volatile memory (e.g., NVRAM) or a ROM such as flash memory. Flash memory is a non-volatile computer storage medium that can be electronically erased and reprogrammed.

The BIOS 510 can be loaded and executed as a sequence program each time the computer system 500 is started. The BIOS 510 can recognize, initialize, and test hardware present in a given computing system based on the set of configurations. The BIOS 510 can perform self-test, such as a Power-on-Self-Test (POST), on the computer system 500. This self-test can test functionality of various hardware components such as hard disk drives, optical reading devices, cooling devices, memory modules, expansion cards and the like. The BIOS can address and allocate an area in the memory 520 in to store an operating system. The BIOS 510 can then give control of the computer system to the OS.

The BIOS 510 of the computer system 500 can include a BIOS configuration that defines how the BIOS 510 controls various hardware components in the computer system 500. The BIOS configuration can determine the order in which the various hardware components in the computer system 500 are started. The BIOS 510 can provide an interface (e.g., BIOS setup utility) that allows a variety of different parameters to be set, which can be different from parameters in a BIOS default configuration. For example, a user (e.g., an administrator) can use the BIOS 510 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 580 can be a specialized microcontroller embedded on the motherboard of the computer system. For example, the management controller 580 can be a BMC or a RMC. The management controller 580 can manage the interface between system management software and platform hardware. Different types of sensors built into the computer system can report to the management controller 580 on parameters such as temperature, cooling fan speeds, power status, operating system status, etc. The management controller 580 can monitor the sensors and have the ability to send alerts to an administrator via the network interface 550 if any of the parameters do not stay within preset limits, indicating a potential failure of the system. The administrator can also remotely communicate with the management controller 580 to take some corrective action such as resetting or power cycling the system to restore functionality.

The northbridge 560 can be a chip on the motherboard that can be directly connected to the processor 540 or can be integrated into the processor 540. In some instances, the northbridge 560 and the southbridge 570 can be combined into a single die. The northbridge 560 and the southbridge 570, manage communications between the processor 540 and other parts of the motherboard. The northbridge 560 can manage tasks that require higher performance than the southbridge 570. The northbridge 560 can manage communications between the processor 540, the memory 520, and video controllers (not shown). In some instances, the northbridge 560 can include a video controller.

The southbridge 570 can be a chip on the motherboard connected to the northbridge 560, but unlike the northbridge 560, is not directly connected to the processor 540. The southbridge 570 can manage input/output functions (e.g., audio functions, BIOS, Universal Serial Bus (USB), Serial Advanced Technology Attachment (SATA), Peripheral Component Interconnect (PCI) bus, PCI eXtended (PCI-X) bus, PCI Express bus, Industry Standard Architecture (ISA) bus, Serial Peripheral Interface (SPI) bus, Enhanced Serial Peripheral Interface (eSPI) bus, System Management Bus (SMBus), etc.) of the computer system 500. The southbridge 570 can be connected to or can include within the southbridge 570 the management controller 580, Direct Memory Access (DMAs) controllers, Programmable Interrupt Controllers (PICs), and a real-time clock.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In one or more exemplary designs, the functions described can be implemented in hardware, software, firmware, or any combination thereof. If implemented in software, the functions can be stored on or transmitted over as one or more instructions or code on a non-transitory computer-readable medium. Non-transitory computer-readable media includes both computer storage media and communication media including any medium that facilitates transfer of a computer program from one place to another. A storage media can be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A method for managing a power supply unit (PSU) associated with a system board, by a control circuit, comprising:
routing a standby power port of the system board to a standby power port of the PSU;
monitoring at least one electrical parameter for the standby power port of the system board by using a sensor;
determining that the at least one electrical parameter meets a criteria; and
transmitting an enable signal configured for enabling a main power port of the PSU and rerouting the standby power port of the system board to the main power port of the PSU, in response to determining that the at least one electrical parameter meets the criteria.

2. The method of claim 1, further comprising:
determining that the at least one electrical parameter no longer meets the criteria; and
transmitting a disable signal configured for disabling a main power port of the PSU and rerouting the standby power port of the system board to the standby power port of the PSU, in response to determining that the at least one electrical parameter no longer meets the criteria.

3. The method of claim 2, wherein transmitting the disable signal comprises discontinuing the enable signal.

4. The method of claim 1, wherein the sensor is configured for generating a current signal corresponding to an amount of electrical current flowing into the standby port of the system board.

5. The method of claim 4, wherein the monitoring comprises calculating the at least one electrical parameter based on the current signal.

6. The method of claim 5, wherein the at least one electrical parameter comprises at least one of a measure of electrical current or a measure of electrical power.

7. The method of claim 1, wherein the standby power port of the system board is selectively coupled to at least one of the main power port of the PSU or the standby power port of the PSU via a switching circuit; and
wherein the routing comprises configuring the switching circuit to couple the standby power port of the PSU to the standby power port of the system board, and wherein the re-routing comprises reconfiguring the switch circuit to couple the main power port of the PSU to the standby power port of the system board.

8. A control circuit for managing a power supply unit (PSU) associated with a system board comprising:
a switching circuit for selectively coupling a standby power port of the system board to one of a standby power port of the PSU or a main power port of the PSU;
a sensor for generating current signals corresponding to a current flowing into the standby power port of the system board; and
a logic circuit, the logic circuit configured for
causing the switching circuit to initially route a standby power port of the system board to a standby power port of the PSU;
determining, based on the current signals, that at least one electrical parameter for the standby power port of the system board meets a criteria; and
generating an enable signal configured for enabling a main power port of the PSU and causing the switching circuit to route a standby power port of the system board to a main power port of the PSU, in response to determining that the at least one electrical parameter meets the criteria.

9. The control circuit of claim 8, wherein the logic circuit is further configured for:
determining that the at least one electrical parameter no longer meets the criteria; and
transmitting a disable signal configured for disabling a main power port of the PSU and rerouting the standby power port of the system board to the standby power port of the PSU, in response to determining that the at least one electrical parameter no longer meets the criteria.

10. The control circuit of claim 9, wherein transmitting the disable signal comprises discontinuing the enable signal.

11. The control circuit of claim 8, wherein the sensor is configured for generating a current signal corresponding to an amount of electrical current flowing into the standby port of the system board.

12. The control circuit of claim 11, wherein the monitoring comprises calculating the at least one electrical parameter based on the current signal.

13. The control circuit of claim 12, wherein the at least one electrical parameter comprises at least one of a measure of electrical current or a measure of electrical power.

14. The control circuit of claim 8, wherein the standby power port of the system board is selectively coupled to at least one of the main power port of the PSU or the standby power port of the PSU via a switching circuit; and
wherein the routing comprises configuring the switching circuit to couple the standby power port of the PSU to the standby power port of the system board, and wherein the re-routing comprises reconfiguring the switch circuit to couple the main power port of the PSU to the standby power port of the system board.
